(19) United States
(12) Patent Application Publication
(10) Pub. No.: US 2025/0246651 A1
(43) Pub. Date: Jul. 31, 2025

(54) FUEL CELL SYSTEM

(71) Applicant: Honda Motor Co., Ltd., Tokyo (JP)

(72) Inventor: Masahiro Yoshizawa, Saitama (JP)

(21) Appl. No.: 19/032,085

(22) Filed: Jan. 19, 2025

(30) Foreign Application Priority Data
Jan. 25, 2024 (JP) 2024-009758

(51) Int. Cl. H01M 8/04664; H01M 8/0267; H01M 8/04029; H01M 8/04082; H01M 8/0438; H01M 8/04746; H01M 8/10; H01M 8/1004

(52) U.S. Cl. CPC H01M 8/04664; H01M 8/0267; H01M 8/04029; H01M 8/04201; H01M 8/04388; H01M 8/04753; H01M 8/1004; H01M 2008/1095; H01M 2250/20

(57) ABSTRACT

A fuel cell system including a fuel cell stack, a fuel gas supply-discharge part, an oxidant gas supply-discharge part, a pressure detection part detecting pressures in an anode flow path and cathode flow path, and a microprocessor. The microprocessor is configured to perform detecting a fuel gas leakage from the anode flow path based on the pressures in the anode flow path and cathode flow path, and the detecting including controlling the fuel gas supply-discharge part and the oxidant gas supply-discharge part to be in a flow-path blocking state in which the anode flow path is blocked from the fuel gas supply-discharge part and the cathode flow path is blocked from the oxidant gas supply-discharge part, and detecting the fuel gas leakage based on change amounts of the pressures in the anode flow path and the cathode flow path from the flow-path blocking state.

### CROSS-REFERENCE TO RELATED APPLICATION

This application is based upon and claims the benefit of priority from Japanese Patent Application No. 2024-009758 filed on Jan. 25, 2024, the content of which is incorporated herein by reference.

### BACKGROUND OF THE INVENTION

### Field of the Invention

This invention relates to a fuel cell system.

### Description of the Related Art

In recent years, technological developments have been made on a fuel cell that contribute to energy efficiency in order to ensure access to energy that is affordable, reliable, sustainable and advanced by more people. As a technology related to this type of fuel cell system, there is a known a fuel cell system that detects leaks of fuel gas containing hydrogen after the operation of the fuel cell has stopped. Such a fuel cell system is described, for example, in Japanese Unexamined Patent Publication No. 2011-181263 (JP 2011-181263 A). In the fuel cell system described in JP 2011-181263 A, the pressure of the fuel gas in the pressure-maintained target range is detected, and if the rate of pressure drop is a set rate or more, it is determined that a gas leakage has occurred from the pressure-maintained target range.

However, using only the pressure detection values of the fuel gas, as in the fuel cell system described in JP 2011-181263 A, makes it difficult to accurately detect gas leakage.

### SUMMARY OF THE INVENTION

An aspect of the present invention is a fuel cell system including: a fuel cell stack including a cell stacked body configured by stacking a plurality of power generation cells in a predetermined direction, an anode flow path in which a fuel gas flows and a cathode flow path in which an oxidant gas flows being provided inside the cell stacked body; a fuel gas supply-discharge part configured to supply the fuel gas into the anode flow path and discharge the fuel gas from the anode flow path; an oxidant gas supply-discharge part configured to supply the oxidant gas to the cathode flow path and discharge the oxidant gas from the cathode flow path; a pressure detection part configured to detect a pressure in the anode flow path and a pressure in the cathode flow path; and an electronic control unit including a microprocessor and a memory connected to the microprocessor. The microprocessor is configured to perform detecting a leakage of the fuel gas from the anode flow path, based on the pressure in the anode flow path and the pressure in the cathode flow path detected by the pressure detection part, and the detecting including controlling the fuel gas supply-discharge part and the oxidant gas supply-discharge part so as to be in a flow-path blocking state in which the anode flow path is blocked from the fuel gas supply-discharge part and the cathode flow path is blocked from the oxidant gas supply-discharge part with that the pressure in the anode flow path and the pressure in the cathode flow path maintained at a predetermined value after an operation of a fuel cell is stopped, and further detecting the leakage of the fuel gas based on a change amount or a change rate of the pressure in the anode flow path from the flow-path blocking state and a change amount or a change rate of the pressure in the cathode flow path from the flow-path blocking state.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating a configuration of a main part of a fuel cell system according to an embodiment of the present invention

FIG. 2 is a perspective view schematically showing an overall configuration of a fuel cell stack included in the fuel cell system of FIG. 1;

FIG. 3 is a cross-sectional view of a main part of a cell stacked body included in the fuel cell stack of FIG. 2;

FIG. 4 is a perspective view showing a schematic configuration of a unitized electrode assembly included in the fuel cell stack of FIG. 2;

FIG. 5 is a rear view of a separator included in the fuel cell stack of FIG. 2;

FIG. 6 is a cross-sectional view taken along line VI-VI in FIG. 1;

FIG. 7 is a block diagram illustrating a control configuration of the fuel cell system according to the embodiment of the present invention;

FIG. 8 is a flowchart illustrating an example of processing executed by an ECU of FIG. 7; and

FIG. 9 is a diagram illustrating an example of an operation by the fuel cell system according to the embodiment of the present invention.

### DETAILED DESCRIPTION OF THE INVENTION

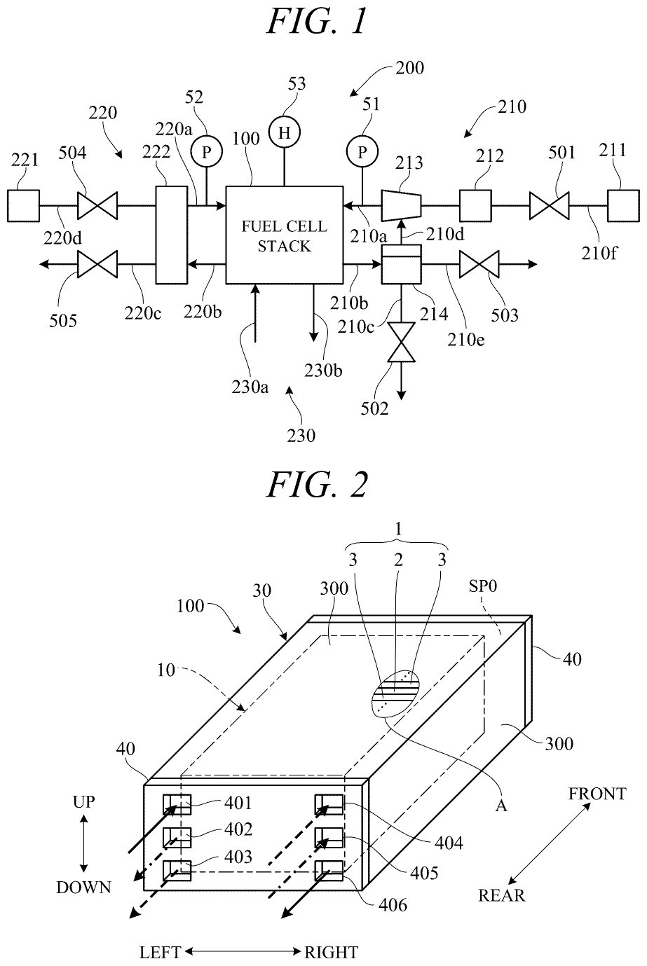

Hereinafter, an embodiment of the present invention will be described with reference to FIGS. 1 to 9. FIG. 1 is a block diagram schematically illustrating a configuration of a main part of a fuel cell system 200 according to an embodiment of the present invention. The fuel cell system 200 is mounted on a vehicle, for example, and generates electric power for driving the vehicle. As illustrated in FIG. 1, the fuel cell system 200 includes a fuel cell stack 100 formed by stacking a plurality of power generation cells, a fuel gas supply/discharge part 210, an oxidant gas supply/discharge part 220, and a cooling medium supply/discharge part 230. The fuel gas and the oxidant gas may also be referred to as an anode gas and a cathode gas, respectively.

The fuel gas supply/discharge part 210 includes a tank 211 that stores a high-pressure fuel gas, an injector 212 that injects the fuel gas, and an ejector 213. The fuel gas in the tank 211 is supplied to the fuel cell stack 100 via the injector 212, the ejector 213, and a supply flow path 210a. The fuel gas is an anode gas (for example, hydrogen gas) containing hydrogen. From the fuel cell stack 100, the fuel gas (fuel exhaust gas) is discharged via a discharge flow path 210b.

A gas-liquid separator 214 is provided in the discharge flow path 210b, and moisture contained in the fuel exhaust gas is separated from the fuel exhaust gas by the gas-liquid separator 214. The separated moisture is discharged via a drain flow path 210c. In the ejector 213, a negative pressure is generated by the flow of the fuel gas discharged from the injector 212. By this negative pressure, the fuel exhaust gas after moisture is separated by the gas-liquid separator 214 is sucked via a circulation flow path 210d and joins the fuel gas injected from the injector 212. A part of the fuel exhaust gas is discharged via a purge flow path 210e without being refluxed to the ejector 213.

In the fuel gas supply/discharge part 210, on-off valves 501 to 503 are provided on a supply side for supplying the fuel gas to the fuel cell stack 100 and a discharge side for discharging the fuel gas from the fuel cell stack 100. Specifically, the on-off valve 501 on the supply side is provided in a flow path 210f between the tank 211 and the injector 212, and the on-off valves 502 and 503 on the discharge side are provided in the drain flow path 210c and the purge flow path 210e, respectively.

The on-off valves 501 to 503 are, for example, electromagnetic valves that open and close when a solenoid is excited or demagnetized according to an electric signal. During the operation (during power generation) of the fuel cell, the on-off valves 501 to 503 open or are opened at an appropriate timing. When the on-off valves 501 to 503 are closed, the flow paths 210a and 210b on the supply side and the discharge side of the fuel gas are blocked, and the fuel gas can be enclosed in the fuel cell stack 100. An on-off valve can be provided at another position as long as the on-off valve is provided on the supply side and the discharge side of the fuel gas.

The oxidant gas supply/discharge part 220 includes a compressor 221 that compresses the oxidant gas to a high pressure, and a humidifier 222 that humidifies the oxidant gas. The oxidant gas compressed by the compressor 221 is humidified by the humidifier 222 and supplied to the fuel cell stack 100 via the supply flow path 220a. The oxidant gas is a cathode gas (for example, air) containing oxygen. From the fuel cell stack 100, the oxidant gas (oxidant exhaust gas) containing moisture is discharged via the discharge flow path 220b. The oxidant gas is discharged via the humidifier 222 and the flow path 220c.

In the oxidant gas supply/discharge part 220, on-off valves 504 and 505 are provided on a supply side for supplying the oxidant gas to the fuel cell stack 100 and a discharge side for discharging the oxidant gas from the fuel cell stack 100. Specifically, the on-off valve 504 on the supply side is provided in a flow path 220d between the compressor 221 and the humidifier 222, and the on-off valve 505 on the discharge side is provided in the flow path 210c downstream of the humidifier 222. The fuel gas and the oxidant gas may be referred to as a reaction gas without being distinguished from each other.

The on-off valves 504 and 505 are, for example, electromagnetic valves that opens and closes when a solenoid is excited or demagnetized according to an electric signal. During the operation (during power generation) of the fuel cell, the on-off valves 504 and 505 open or are opened at an appropriate timing. When the on-off valves 504 and 505 are closed, the flow paths 220a and 220b on the supply side and the discharge side of the oxidant gas are blocked, and the oxidant gas can be enclosed in the fuel cell stack 100. An on-off valve can be provided at another position as long as the on-off valve is provided on the supply side and the discharge side of the oxidant gas.

The cooling medium supply/discharge part 230 includes a pump (not illustrated), and a cooling medium discharged from the pump is supplied to the fuel cell stack 100 via the supply flow path 230a. The cooling medium is, for example, water. From the fuel cell stack 100, the cooling medium is discharged via a discharge flow path 230b. The discharged cooling medium is cooled by heat exchange in a radiator, and is supplied to the fuel cell stack 100 again via the supply flow path 230a.

A pressure sensor 51 that detects the pressure of the fuel gas is connected to the fuel gas supply flow path 210a. A pressure sensor 52 that detects the pressure of the oxidant gas is connected to the oxidant gas supply flow path 220a. A hydrogen sensor 53 that detects the leakage of fuel gas into a case of the fuel cell stack 100 is connected to the fuel cell stack 100. Although not illustrated, the fuel cell system 200 is also provided with a temperature sensor that detects the temperature of the reaction gas and the like. The operation of the fuel cell system 200 is controlled on the basis of signals from these sensors.

FIG. 2 is a perspective view schematically showing an overall configuration of the fuel cell stack 100. Hereinafter, for the sake of convenience, three-axis directions orthogonal to each other as illustrated in the drawing are defined as a front-rear direction, a left-right direction, and an up-down direction, and a configuration of each part will be described according to such definitions. These directions may be different from a front-rear direction, a left-right direction, and an up-down direction of the vehicle. For example, the front-rear direction of FIG. 2 may be the front-rear direction, the left-right direction, or the up-down direction of the vehicle.

As illustrated in FIG. 2, the fuel cell stack 100 includes a cell stacked body 10, end units 40 disposed on both ends in the front-rear direction of the cell stacked body 10, and a case 30 surrounding the cell stacked body 10, and the whole of the fuel cell stack 100 has a substantially rectangular parallelepiped shape.

The case 30 has four substantially rectangular side walls 300, each facing the top, right, bottom, and left surfaces of the cell stacked body 10. These four side walls 300 form a substantially box-shaped housing space SP0 with open the front and rear surfaces. The case 30 is composed of metals such as aluminum or iron. The hydrogen sensor 53 in FIG. 1 is provided in the housing space SP0 outside the cell stacked body 10.

Although not illustrated, the end unit 40 has a plurality of plates stacked in the front-rear direction. More specifically, the end units 40 include terminal plates arranged adjacent to both front and rear end surfaces of the cell stacked body 10, insulating plates arranged outside the terminal plates in the front-rear direction, and end plates arranged outside the insulating plates in the front-rear direction.

The terminal plate is a substantially rectangular metal plate member and has a terminal portion for extracting power generated by electrochemical reactions in the cell stacked body 10. The insulating plate is a substantially rectangular plate member made of non-conductive resin or rubber, and electrically insulates the terminal plate and the end plate. The end plate is a plate member made of metal or high-strength resin.

In part “A” of FIG. 2, a portion of the side wall 300 of the case 30 is shown as broken. As illustrated in part “A” of FIG. 2, the cell stacked body 10 is a stacked body including a plurality of power generation cells 1 (for convenience, only a single cell 1 is illustrated). The power generation cell 1 has a unitized electrode assembly (hereinafter, referred to as a “UEA”) 2, and separators 3 arranged on both front and rear sides of the UEA 2 to sandwich the UEA 2. The UEA 2 and the separator 3 are alternately arranged in the front-rear direction. The UEA 2 can also be referred to as a membrane electrode structure or a membrane electrode member.

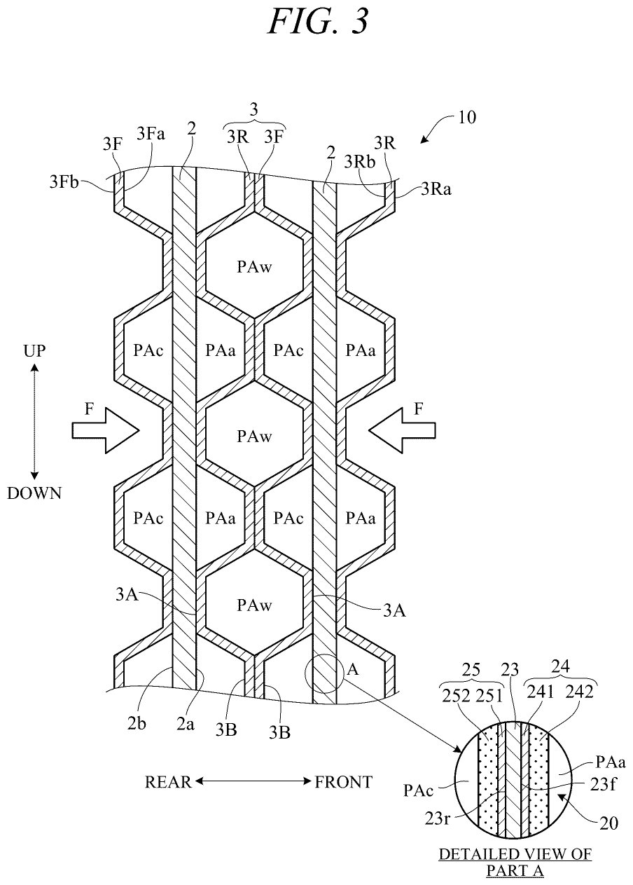

FIG. 3 is a cross-sectional view of a main part of the cell stacked body 10. As shown in FIG. 3, the separator 3 has a front plate 3F and a rear plate 3R, which are a pair of metal thin plates with a corrugated cross-section. The front plate 3F extends in the up-down and left-right directions and has a front surface 3Fa and a rear surface 3Fb. The rear plate 3R extends in the up-down, and left-right directions, and has a front surface 3Ra and a rear surface 3Rb. The rear surface 3Fb of the front plate 3F and the front surface 3Ra of the rear plate 3R facing each other are joined together by welding or the like at their outer peripheral edges. Thus, the front plate 3F and the rear plate 3R are integrally joined to form a separator 3. The separator 3 uses a conductive material with excellent corrosion resistance, such as stainless steel, titanium, or titanium alloy.

Inside the separator 3 enclosed by the front plate 3F and the rear plate 3R, that is, between the rear surface 3Fb of the front plate 3F and the front surface 3Ra of the rear plate 3R, a cooling medium flow path PAw through which a cooling medium flows is formed. The generating surface of the power generation cell 1 is cooled by the flow of the cooling medium.

The surfaces of the separator 3 facing the UEA 2, that is, the front surface 3Fa of the front plate 3F and the rear surface 3Rb of the rear plate 3R, are formed into an uneven shape by press molding or the like to form a gas flow path between the separator 3 and the UEA 2. More specifically, the separator 3 has a pair of front and rear rib portions 3A protruding towards the UEA 2, and a pair of front and rear concave portions 3B, which are concavely formed in continuation to the pair of front and rear rib portions 3A

The pair of front and rear rib portions 3A contact the front surface 2a and the rear surface 2b of the UEA 2. In the cell stacked body 10, a compressive load F is applied in the front-rear direction during the assembly of the fuel cell stack 100, and this compressive load F is maintained after the assembly of the fuel cell stack 100 is completed. Therefore, a predetermined surface pressure due to the compressive load F acts in the front-rear direction on the UEA 2 through the rib portion 3A.

Between the front surface 2a of the UEA 2 and the rear plate 3R of the separator 3 facing this front surface 2a, an anode flow path PAa through which fuel gas flows is formed by the concave portion 3B. Between the rear surface 2b of the UEA 2 and the front plate 3F of the separator 3 facing this rear surface 2b, a cathode flow path PAc through which oxidant gas flows is formed by the concave portion 3B.

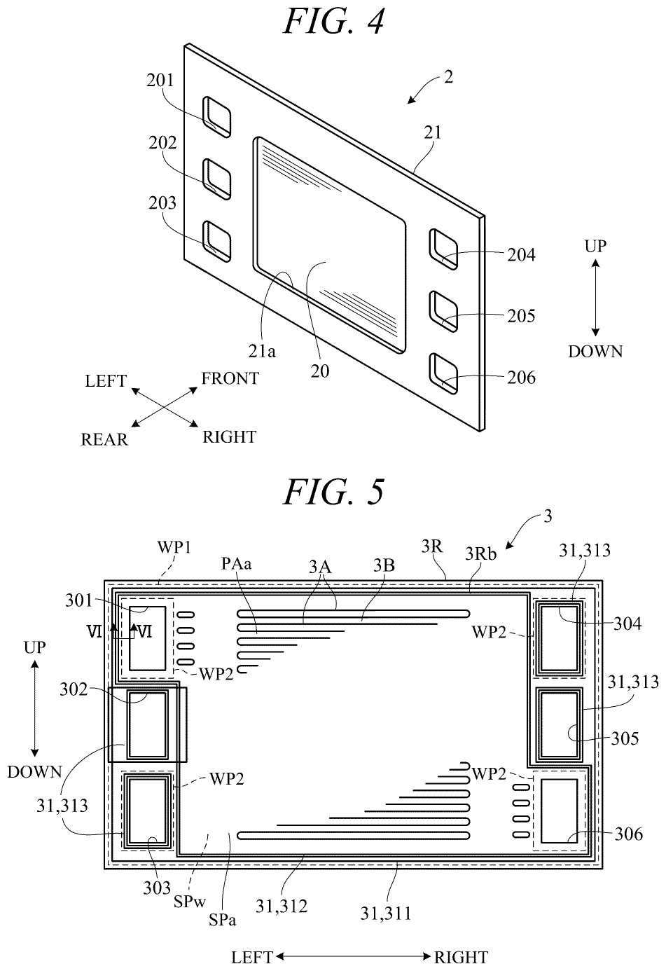

FIG. 4 is a perspective view showing a schematic configuration of the UEA 2. As shown in FIG. 4, the UEA 2 includes a substantially rectangular membrane electrode assembly 20 (hereinafter, referred to as a “MEA”) and a frame 21 that supports the MEA 20. As shown in the detailed view of part “A” in FIG. 3, the MEA 20 has an electrolyte membrane 23, an anode electrode 24 provided on a front surface 231 of the electrolyte membrane 23, and a cathode electrode 25 provided on a rear surface 232 of the electrolyte membrane 23.

The electrolyte membrane 23 is, for example, a solid polymer electrolyte membrane, and a thin film of perfluorosulfonic acid polymer containing moisture can be used. Not only a fluorine-based electrolyte but also a hydrocarbon-based electrolyte can be used.

The anode electrode 24 has an electrode catalyst layer 241 formed on the front surface 23f of the electrolyte membrane 23 and served as a reaction field for electrode reaction, and a gas diffusion layer 242 formed on the front surface of the electrode catalyst layer 241 to spread and supply the fuel gas. The cathode electrode 25 has an electrode catalyst layer 251 formed on the rear surface 23r of the electrolyte membrane 23 and served as a reaction field for electrode reaction, and a gas diffusion layer 252 formed on the rear surface of the electrode catalyst layer 251 to spread and supply the oxidant gas. An intermediate layer (underlayer) can also be provided between the electrode catalyst layer 241 and the gas diffusion layer 242. An intermediate layer (underlayer) can also be provided between the electrode catalyst layer 251 and the gas diffusion layer 252.

The electrode catalyst layers 241 and 251 include a catalyst metal that promotes the electrochemical reaction of hydrogen contained in the fuel gas and oxygen contained in the oxidant gas, an electrolyte (such as an ionomer) with proton conductivity, and carbon particles with electron conductivity, and the like. The gas diffusion layers 242 and 252 are made of conductive members with gas permeability, such as carbon porous bodies.

In the anode electrode 24, the fuel gas (hydrogen) supplied through the anode flow path PAa is ionized by an action of a catalyst, passes through the electrolyte membrane 23, and moves to the cathode electrode side. Electrons generated at this time pass through an external circuit and are extracted as electric energy. In the cathode electrode 25, an oxidant gas (oxygen) supplied via the cathode flow path PAc reacts with hydrogen ions guided from the anode electrode 24 and electrons moved from the anode electrode 24 to generate water. The generated water gives an appropriate humidity to the electrolyte membrane 23, and excess water is discharged to an outside of the UEA 2 along the gas flow.

As illustrated in FIG. 4, the frame 21 is a thin plate having a substantially rectangular shape, and is made of an insulating resin, rubber, or the like. A substantially rectangular opening 21a is provided in a central portion of the frame 21. The MEA 20 is disposed to cover the entire opening 21a and a peripheral portion of the MEA 20 is supported by the frame 21. Three through-holes 201 to 203 penetrating the frame 21 in the front-rear direction are opened side by side in the up-down direction on the left side of the opening 21a of the frame 21. Three through-holes 204 to 206 penetrating the frame 21 in the front-rear direction are opened side by side in the up-down direction on the right side of the opening 21a of the frame 21.

FIG. 5 is a rear view (viewed from the rear) of the separator 3 arranged in front of UEA 2, showing the rear surface 3Rb of the rear plate 3R (FIG. 3). As illustrated in FIG. 5, although some illustrations are omitted, a plurality of rib portions 3A facing the MEA 20 of the UEA 2 are extended in the left-right by press processing in the central part of the rear surface 3Rb in the left-right direction. A concave portion 3B is provided between the rib portions 3A and 3A adjacent to each other in the up-down direction. An anode flow path PAa is formed between the concave portion 3B and the front surface 2a of the MEA 20. Although not illustrated, the rib portions 3A and the concave portions 3B are similarly formed by press processing on the front surface of the front plate 3F of the separator 3, and a cathode flow path PAc is formed between the concave portion 3B and the rear surface 2b of the MEA 20.

In the separator 3, through-holes 301 to 306 penetrating the separators 3 in the front-rear direction are opened at positions corresponding to the through-holes 201 to 206 (FIG. 4) of the frame 21. The through-holes 301 to 306 communicate with the through-holes 201 to 206 of the frame 21, respectively. The set of the through-holes 201 to 206 and 301 to 306 communicating with each other forms a plurality of flow paths penetrating the cell stacked body 101 and extending in the front-rear direction.

As shown in FIG. 2, in the rear end unit (wet side end unit) 40, a plurality of through-holes 401 to 406 penetrating the end unit 40 in the front-rear direction are opened at positions corresponding to the through-holes 201 to 206 and 301 to 306. In the front end unit (dry side end unit) 40, the through-holes 401 to 406 are not opened. The through-holes 401 and 406 are a supply port and a discharge port for the fuel gas, respectively. The supply flow path 210a and the discharge flow path 210b in FIG. 1 are connected to the through-holes 401 and 406, respectively. As shown by the solid arrows in FIG. 2, the fuel gas is supplied to the fuel cell stack 100 through the through-hole 401, and the fuel gas is discharged from the fuel cell stack 100 through the through-hole 406.

The through-holes 404 and 403 are a supply port and a discharge port for the oxidant gas, respectively. The supply flow path 220a and the discharge flow path 220b in FIG. 1 are connected to the through-holes 404 and 403, respectively. As shown by the dotted arrows in FIG. 2, the oxidant gas is supplied to the fuel cell stack 100 through the through-hole 404, and the oxidant gas is discharged from the fuel cell stack 100 through the through-hole 403.

The through-holes 405 and 402 are a supply port and a discharge ports for the cooling medium, respectively. The supply flow path 230a and the discharge flow path 230b in FIG. 1 are connected to the through-holes 405 and 402, respectively. As shown by the chain-dotted arrows in FIG. 2, the cooling medium is supplied to the fuel cell stack 100 through the through-hole 405, and the cooling medium is discharged from the fuel cell stack 100 through the through-hole 402.

As illustrated in FIG. 5, a welded portion WP1 (dotted line) is provided on the entire outer peripheral edge portion of the separator 3, and the rear plate 3R and the front plate 3F are integrally joined via the welded portion WP1. In addition, welded portions WP2 (dotted line) are provided around the through-holes 301, 303, 304, and 306 for gas supply and gas discharge so as to individually surround the through-holes 301, 303, 304 and 306 over the entire circumference. As a result, a cooling medium flow space SPw in which the outer peripheral edge portion of the separator 3 and the through-holes 301, 303, 304 and 306 are sealed is formed inside the separator 3 (between the rear plate 3R and the front plate 3F), and the cooling medium is supplied to the cooling medium flow space SPw and discharged from the cooling medium flow space SPw via the through-holes 302 and 305.

On the rear surface 3Rb of the rear plate 3R, a bead portion 31 for sealing which protrudes backward toward the frame 21 of the UEA 2 is provided outside an anode flow path PAa. The bead portion 31 includes an outer bead portion 311, an inner bead portion 312, and an individual bead portion 313, and which extende without intersecting each other.

The outer bead portion 311 extends in a substantially rectangular shape along the outer peripheral edge of the rear plate 3R so as to surround all the through-holes 301 to 306. The inner bead portion 312 extends in a substantially rectangular shape so as to surround the anode flow path PAa, and partially extends to the vicinity of the outer bead portion 311 so as to surround the through-holes 301 and 306 for supplying and discharging the fuel gas. A plurality of the individual bead portions 313 are provided between the outer bead portion 311 and the inner bead portion 312 so as to individually surround the through-hole 302 to 305.

Although not illustrated, the bead portion 31 for sealing, which protrudes forward toward the frame 21 of the UEA 2 is similarly provided on the front surface 3Fa of the front plate 3F. However, unlike the inner bead portion 312 of the rear surface 3Rb of the rear plate 3R, the inner bead portion 312 of the front surface 3Fa of the front plate 3F extends in a substantially rectangular shape so as to surround the cathode flow path PAc, and partially extends to the vicinity of the outer bead portion 311 so as to surround the through-holes 304 and 303 for supplying and discharging the oxidant gas. In addition, a plurality of individual bead portions 313 of the front surface 3Fa of the front plate 3F are provided between the outer bead portion 311 and the inner bead portion 312 so as to individually surround the through-holes 301, 302, 305 and 306.

By providing the bead portion 31 on the rear surface 3Rb of the rear plate 3R in this manner, a gas flow space SPa of which the periphery is sealed is formed from the through-hole 301 to the anode flow path PAa and the through-hole 306. As a result, the fuel gas flows in a sealed state in the gas flow space SPa along the rear surface 3Rb of the rear plate 3R. In addition, by providing the bead portion 31 on the front surface 3Fa of the front plate 3F, a gas flow space (not illustrated) of which the periphery is sealed is formed from the through-hole 304 to the cathode flow path PAc and the through-hole 303. As a result, the oxidant gas flows in a sealed state in the gas flow space (not illustrated) along the front surface 3Fa of the front plate 3F.

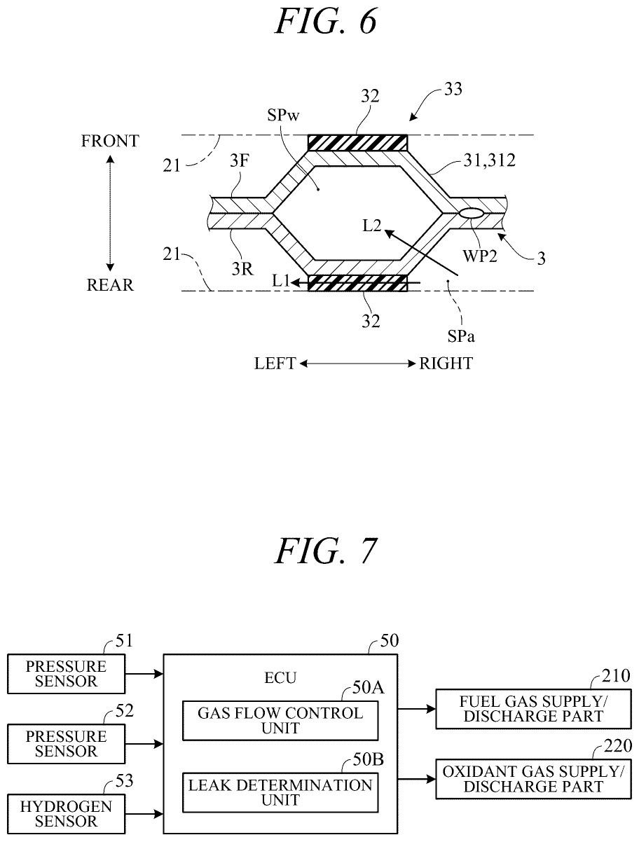

FIG. 6 is a cross-sectional view of a main part of the separator 3 (a cross-sectional view taken along line VI-VI in FIG. 5) illustrating the configuration of the sealing portion 33. As illustrated in FIG. 6, a sealing material 32 made of a rubber material or a resin material is fixed to the surface of the bead portion 31 (the inner bead portion 312 in FIG. 6), thereby forming the sealing portion 33. The bead portion 31 is in close contact with the front surface and the rear surface of the frame 21 via the sealing material 32. The sealing material 32 may be omitted, and the bead portion 31 may be brought into close contact with the front surface and the rear surface of the frame 21.

Incidentally, a sealing defect may occur due to deflection of the separator 3, deterioration of the sealing material 32, or the like. In this case, as indicated by an arrow L1 in FIG. 6, the fuel gas may leak to the outside of the gas flow space SPa and further to the outside of the cell stacked body 10 via the bead portion 31 or the sealing material 32. That is, out-leakage in which the fuel gas leaks to the outside of the cell stacked body 10 may occur. In addition, when a welding defect such as cracks or damage occurs in the welded portions WP1 and WP2 where the front plate 3F and the rear plate 3R are joined, the fuel gas may leak from the gas flow space SPa to the cooling medium flow space SPw as indicated by an arrow L2 in FIG. 6. That is, cross-leakage in which the fuel gas leaks to another flow path may occur.

In the present embodiment, the fuel cell system 200 is configured as follows so that such fuel gas leakage can be accurately detected. The leakage may occur not only in the fuel gas but also in the oxidant gas, but in the following description, it is regarded that there is no oxidant gas leakage for convenience.

FIG. 7 is a block diagram illustrating a control configuration of the fuel cell system 200 related to fuel gas leakage detection. As illustrated in FIGS. 1 and 7, the fuel cell system 200 includes an ECU 50 as a leakage detection unit, the pressure sensor 51 that detects a pressure P1 (referred to as an anode pressure) of the fuel gas in the anode flow path PAa, the pressure sensor 52 that detects a pressure P2 (referred to as a cathode pressure) of the oxidant gas in the cathode flow path PAc, the hydrogen sensor 53 that detects hydrogen outside the cell stacked body 10 and inside the case, the fuel gas supply/discharge part 210, and the oxidant gas supply/discharge part 220. The fuel gas supply/discharge part 210 includes the injector 212 and the on-off valves 501 to 503, and the oxidant gas supply/discharge part 220 includes the compressor 221 and the on-off valves 504 and 505.

The ECU 50 includes a computer including a processing unit such as a CPU, a storage unit (memory) such as a ROM and a RAM, and other peripheral circuits. The processing unit functions as a gas flow control unit 50A and a leak determination unit 50B by executing a program stored in advance in the storage unit.

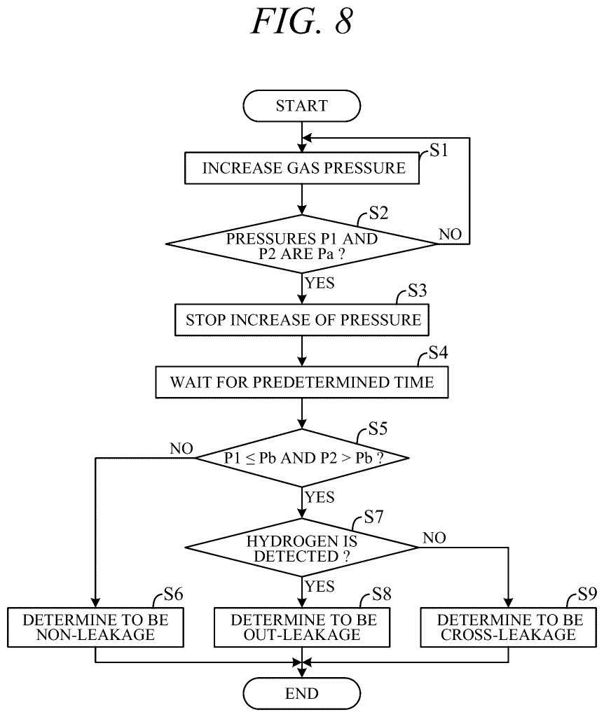

FIG. 8 is a flowchart illustrating an example of processing executed by the processing unit of the ECU. The processing illustrated in the flowchart is started when the operation (power generation) of the fuel cell is stopped by turning off a power switch or an ignition switch of the vehicle. For example, the processing is performed every time the operation of the fuel cell is stopped. The processing of FIG. 8 may be executed every time a predetermined number of times of operation of the fuel cell is performed or every time a predetermined period elapses. At the start of the processing, the anode pressure P1 and the cathode pressure P2 detected by the pressure sensors 51 and 52 are at an initial pressure P0 sufficiently lower than at the time of power generation.

As illustrated in FIG. 8, first, in S1 (S: processing step), the fuel gas supply/discharge part 210 and the oxidant gas supply/discharge part 220 are controlled to increase the pressures of the fuel gas in the anode flow path PAa and the oxidant gas in the cathode flow path PAc in the fuel cell stack 100. Specifically, control signals are output to the on-off valves 501 to 503 of the fuel gas supply/discharge part 210 to open the on-off valve 501 and to close the on-off valves 502 and 503, and in this state, a control signal is output to the injector 212 to supply the fuel gas to the anode flow path PAa. At the same time, control signals are output to the on-off valves 504 and 505 of the oxidant gas supply/discharge part 220 to open the on-off valve 504 and to close the on-off valve 505, and in this state, the control signal is output to the compressor 22 to supply the oxidant gas to the cathode flow path PAc. In this case, the supply amount of gas is adjusted so that the anode pressure P1 and the cathode pressure P2 increase at the same ratio.

Next, in S2, it is determined whether or not the anode pressure P1 and the cathode pressure P2 detected by the pressure sensors 51 and 52 have reached a predetermined value Pa stored in advance. The predetermined value Pa is a value that generates a differential pressure at which a fuel gas leakage phenomenon easily occurs when a sealing defect occurs in the sealing portion 33 or a welding defect occurs in the welded portions WP1 and WP2. When the determination result in S2 is negative, the processing returns to S1, and the increase in gas pressure is continued. When the determination result in S2 is positive, the processing proceeds to S3.

In S3, a control signal is output to the on-off valve 501 to close the on-off valve 501, and a control signal is output to the injector 212 to stop the supply of the fuel gas. As a result, the pressure increase in the anode flow path PAa is stopped, the fuel gas is enclosed in the anode flow path PAa, and the anode pressure P1 is maintained at the predetermined value Pa. At the same time, a control signal is output to the on-off valve 504 to close the on-off valve 504, and a control signal is output to the compressor 221 to stop the supply of the oxidant gas. As a result, the pressure increase in the cathode flow path PAc is stopped, the oxidant gas is enclosed in the cathode flow path PAc, and the cathode pressure P2 is maintained at the predetermined value Pa.

The processing by the gas flow control unit 50A in FIG. 7 has been described above. The gas flow control unit 50A controls the flow of the reaction gas in a flow-path blocking state in which the anode flow path PAa and the cathode flow path PAc are blocked in a state in which the anode pressure P1 and the cathode pressure P2 are each maintained at a predetermined value Pa. In the flow-path blocking state, the fuel gas and the oxidant gas face each other via a MEA 20. Therefore, even in a case where there is no fuel gas leakage, the reaction gas is consumed by the electrochemical reaction, and the pressures P1 and P2 decrease. The pressure decrease amount in this case is a normal decrease amount, and the normal decrease amount can be obtained in advance by experiment, analysis, or the like.

The leak determination unit 50B in FIG. 7 executes processing after S4. In S4, standby is performed for a predetermined time T1 in the flow-path blocking state. The predetermined time T1 is a time required for a significant pressure decrease of the fuel gas to occur when there is a sealing defect or a welding defect. The predetermined time T1 is grasped in advance by experiment, analysis, or the like, and stored in the storage unit.

Next, in S5, it is determined whether or not the anode pressure P1 is equal to or smaller than a predetermined value Pb and the cathode pressure P2 is larger than the predetermined value Pb. The predetermined value Pb is smaller than the predetermined value Pa by a predetermined decrease amount ΔP. The predetermined value Pb is a threshold for specifying occurrence of fuel gas leakage, and is grasped in advance by experiment, analysis, or the like and stored in the storage unit.

In S5, it is determined not only whether P1≤Pb is satisfied but also whether P2>Pb is satisfied. For this reason, it is determined whether or not the anode pressure P1 is significantly smaller than the cathode pressure P2 on the assumption that there is no leak, and this increases the accuracy of leak determination. Instead of the processing of S5, it may be determined whether or not the anode pressure P1 is smaller than the cathode pressure P2 by a predetermined value or more.

When the determination result in S5 is negative, the processing proceeds to S6. In this case, it is determined that there is no fuel gas leakage, and the processing ends. On the other hand, when the determination result in S5 is positive, the processing proceeds to S7, and it is determined on the basis of a signal from the hydrogen sensor 53 whether or not hydrogen is detected in the housing space SP0 outside the cell stacked body 10 and inside the case 30. For example, when a predetermined amount or more of hydrogen is detected by the hydrogen sensor 53, it is determined that hydrogen is detected.

When the determination result in S7 is positive, the processing proceeds to S8. In this case, it is determined that the fuel gas leaks to the outside of the cell stacked body 10 (out-leakage), and the processing is ended. Meanwhile, when the determination result in S7 is negative, the processing proceeds to S9. In this case, it is determined that the fuel gas leaks to the cooling medium flow path PAw (cooling medium flow space SPw) (cross-leakage), and the processing is ended.

With this, the processing regarding the detection of the fuel gas leakage is ended. After the processing of FIG. 8 is ended, the ECU 50 may output the determination result. For example, the determination result may be output to a monitor and displayed, or may be output to a memory and stored. After the end of the processing of FIG. 8, the consumption of the oxidant gas accumulated in the cathode flow path PAc continues due to the electrochemical reaction with the fuel gas.

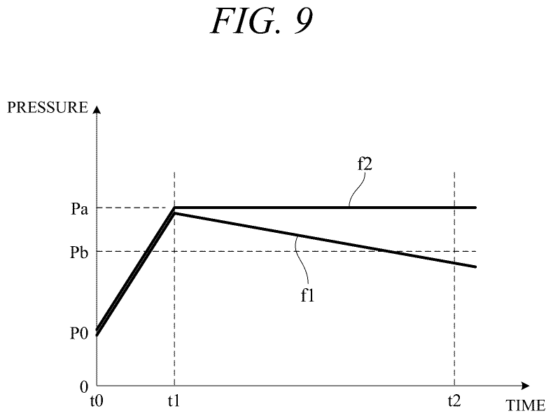

The main operations according to the present embodiment are summarized as follows. FIG. 9 is a diagram illustrating a change in the anode pressure P1 and the cathode pressure P2 with the lapse of time from an initial time point to at which the operation of the fuel cell is stopped. In the drawing, a characteristic f1 indicates a change in the anode pressure P1, and a characteristic f2 indicates a change in the cathode pressure P2. At a time point t0, the fuel gas and the oxidant gas are simultaneously supplied to the anode flow path PAa and the cathode flow path PAc, respectively, in a state where the on-off valves 502, 503, and 505 on the discharge side are closed (S1). As a result, as shown in the characteristics f1 and f2, the anode pressure P1 and the cathode pressure Pc gradually increase from the initial pressure P0.

When the anode pressure P1 and the cathode pressure P2 increase to the predetermined value Pa at a time point t1, the supply of the fuel gas and the oxidant gas is stopped (S3). As a result, the anode flow path PAa and the cathode flow path PAc in the fuel cell stack are held in the flow-path blocking state in which the fuel gas and the oxidant gas of the predetermined pressure Pa are enclosed. At the time point t1, the anode pressure P1 and the cathode pressure P2 are equal, and thus gas cross leakage does not occur between the anode flow path PAa and the cathode flow path PAc.

When there is a sealing defect or a welding defect of the separator 3 on the anode flow path PAa side, the fuel gas leaks from the anode flow path PAa, and as illustrated in FIG. 9, the anode pressure P1 gradually decreases with the lapse of time from the time point t1. On the other hand, since there is no oxidant gas leakage from the cathode flow path PAc, the cathode pressure P2 is constant. In practice, the fuel gas and the oxidant gas are consumed by reacting with each other, which causes a decrease in the anode pressure P1 and the cathode pressure P2, but in FIG. 6, for convenience, characteristics f1 and f2 are set ignoring this point.

In a case where the anode pressure P1 is larger than the predetermined value Pb and the cathode pressure P2 is larger than the predetermined value Pb at a time point t2 which is after the predetermined time T1 has elapsed from the time point t1, it is determined that there is no fuel gas leakage (S6). On the other hand, as illustrated in FIG. 9, when the anode pressure P1 becomes equal to or smaller than the predetermined value Pb although the cathode pressure P2 is larger than the predetermined value Pb, it is determined that the pressure decrease due to the reaction does not occur, and the pressure decrease due to the leakage occurs. That is, it is determined that cross-leakage from the anode flow path PAa to the cooling medium flow path PAw or out-leakage from the anode flow path PAa to the outside of the cell stacked body 10 has occurred.

Further, when hydrogen is detected by the hydrogen sensor 53, the leakage is specified as the out-leakage of the fuel gas, and when hydrogen is not detected, the leakage is specified as the cross-leak of the fuel gas (S8, S9). As a result, it is possible to determine not only the presence or absence of the fuel gas leakage but also a leakage mode.

According to the present embodiment, the following operations and effects are achievable.
(1) The fuel cell system 200 includes: a fuel cell stack 100 that has a cell stacked body 10 formed by stacking a plurality of power generation cells 1 and is provided with the anode flow path PAa through which a fuel gas flows and the cathode flow path PAc through which an oxidant gas flows inside the cell stacked body 10; a fuel gas supply/discharge part 210 that supplies the fuel gas to the anode flow path PAa and discharges the fuel gas from the anode flow path PAa; an oxidant gas supply/discharge part 220 that supplies the oxidant gas to the cathode flow path PAc and discharges the oxidant gas from the cathode flow path PAc; pressure sensors 51 and 52 that detect the pressure P1 of the anode flow path PAa and the pressure P2 of the cathode flow path PAc; and an ECU 50 as a leakage detection unit that detects fuel gas leakage from the anode flow path PAa on the basis of the anode pressure P1 and the cathode pressure P2 detected by the pressure sensors 51 and 52 (FIGS. 1, 2, and 7). The ECU 50 controls the fuel gas supply/discharge part 210 and the oxidant gas supply/discharge part 220 so as to be in a flow-path blocking state in which the anode flow path PAa is blocked from the fuel gas supply/discharge part 210 and the cathode flow path PAc is blocked from the oxidant gas supply/discharge part 220 in a state in which the anode pressure P1 and the cathode pressure P2 are each maintained at the predetermined value Pa after an operation of a fuel cell stops, and further, detects fuel gas leakage on the basis of a change amount of the anode pressure P1 and a change amount of the cathode pressure P2 from the flow-path blocking state (FIG. 8).

As described above, after the operation of the fuel cell is stopped, the fuel gas and the oxidant gas are supplied to the anode flow path PAa and the cathode flow path PAc, respectively, to detect the fuel gas leakage, so that it is not necessary to add a dedicated flow path or the like for leakage detection, and the leakage detection can be performed with a simple configuration. In addition, since the fuel gas leakage is determined not only on the basis of the change amount of the anode pressure P1 but also on the basis of the change amount of the cathode pressure P2, the occurrence of the fuel gas leakage can be accurately determined even in a case where the anode pressure P1 decreases due to the reaction between the fuel gas and the oxidant gas.
(2) The ECU 50 determines that the leakage occurs in the anode flow path PAa on the basis of the change amount of the anode pressure P1 relative to the change amount of the cathode pressure P2 from the flow-path blocking state, that is, in a case where the anode pressure P1 is equal to or smaller than the predetermined value Pb although the cathode pressure P2 is larger than the predetermined value Pb (FIG. 8). As a result, it is possible to accurately determine the presence or absence of the fuel gas leakage.
(3) The fuel cell system 200 further includes a cooling medium supply/discharge part 230 that supplies a cooling medium to the cooling medium flow path PAw adjacent to the anode flow path PAa through the rear plate 3R (partition wall) and discharges the cooling medium from the cooling medium flow path PAw (FIGS. 1 and 2). When the degree of decrease in the anode pressure P1 with the lapse of time from the flow-path blocking state is larger than the degree of decrease in the cathode pressure P2, the ECU 50 determines that the fuel gas leakage occurs from the anode flow path PAa to the outside of the cell stacked body 10 or from the anode flow path PAa to the cooling medium flow path PAw (FIG. 8). As a result, it can be determined that the mode of the fuel gas leakage is any one of out-leakage to the outside of the cell stacked body 10 or cross-leakage to the cooling medium flow path PAw.
(4) The fuel cell system 200 further includes a hydrogen sensor 53 that detects the fuel gas outside the cell stacked body 10 (FIG. 1). In a state where the degree of decrease in the anode pressure P1 with the lapse of time from the flow-path blocking state is larger than the degree of decrease in the cathode pressure P2, when the hydrogen sensor 53 detects the fuel gas, the ECU 50 determines that the fuel gas leakage occurs from the anode flow path PAa to the outside of the cell stacked body 10, and when the hydrogen sensor 53 does not detect the fuel gas, the ECU 50 determines that the fuel gas leakage occurs from the anode flow path PAa to the cooling medium flow path PAw (FIG. 8). As a result, the mode of the fuel gas leakage can be specified with a simple configuration. Since the hydrogen sensor 53 is provided not in the cooling medium flow path PAw but in the housing space SP0 in the case, installation of the hydrogen sensor 53 is also easy.
(5) After the operation of the fuel cell is stopped, the ECU 50 controls the fuel gas supply/discharge part 210 and the oxidant gas supply/discharge part 220 so as to simultaneously increase the anode pressure P1 and the cathode pressure P2 to the predetermined value Pa (FIG. 8). As a result, it is possible to early shift to the flow-path blocking state in which the gas pressure increases to the predetermined value Pa, and to complete leakage detection processing in a short time. In addition, since the anode pressure P1 and the cathode pressure P2 are simultaneously increased as values equal to each other, occurrence of cross-leakage due to a differential pressure between the anode pressure P1 and the cathode pressure P2 can be suppressed.

The above fuel cell system 200 can also be used as a method for detecting gas leakage in a fuel cell. That is, it can be used as a gas leakage detection method of the fuel cell, which includes increasing the anode pressure P1 and the cathode pressure P2 to the predetermined value Pa after stopping the operation of the fuel cell to establish a flow-path blocking state (S1-S3), waiting for a predetermined time T1 while maintaining the flow-path blocking state (S4), and detecting a fuel gas leakage based on the change amounts in the anode pressure P1 and the cathode pressure P2 after the predetermined time T1 has elapsed (S5-S9).

The above embodiment can be modified in various forms. Below, some modified examples are described. In the above embodiment, the pressure sensors 51 and 52 as a pressure detection part are connected to the flow paths 210f and 220a, but the pressure detection part is not limited to the above one, as long as detecting the pressures P1 and P2 in the anode flow path and the cathode flow path. The anode pressure P1 and the cathode pressure P2 may be calculated using the detection values of other sensors that detect other physical quantities correlated with these pressures P1 and P2, and the configuration of the pressure detection part is not limited to the above configuration. A leakage detection may be performed by detecting the differential pressure between the anode pressure P1 and the cathode pressure P2, and determining whether the anode pressure P1 is smaller than the cathode pressure P2 and whether the differential pressure is equal to or larger than a predetermined value. In the above embodiment, the predetermined values Pa and Pb are set as constant values, but they may be changed based on temperature detection values, for example.

In the above embodiment, the ECU 50 as a leakage detection unit detects a fuel gas leakage based on whether the pressures P1 and P2 have decreased by a predetermined amount or more after the predetermined time T1 has elapsed from the flow-path blocking state, but it may also detect the fuel gas leakage based on whether the pressures P1 and P2 have decreased by a predetermined amount or more within the predetermined time without waiting for the predetermined time T1 (for example, when P1≤Pb and P2>Pb are satisfied). In the above embodiment, the fuel gas leakage is detected based on the change amount (decrease amount) of the pressures P1 and P2, but it may also be detected based on a change rate of the pressures P1 and P2 (for example, the change rate of the pressures P1 and P2 per unit time, more specifically, the decrease rate), that is, whether the rate of pressure decrease is equal to or larger than a predetermined value. Therefore, the configuration of the leakage detection unit that determines whether the degree of decrease in the anode pressure P1 over time from the flow-path blocking state is larger than the degree of decrease in the cathode pressure P2 is not limited to the above configuration.

In the above embodiment, it is determined whether a leakage has occurred from the anode flow path PAa based on whether P1≤Pb and P2>Pb are satisfied after a predetermined time T1 has elapsed from the flow-path blocking state, but in another aspect, it may be determined whether the leakage has occurred in the anode flow path PAa, based on the change amount or the change rate of the anode pressure P1 relative to the change amount or the change rate of the cathode pressure P2 from the flow-path blocking state. For example, the decrease amount of the anode pressure P1 may be divided by the decrease amount of the cathode pressure P2 to obtain the ratio of the pressure decrease amount, and it may be determined whether the leakage has occurred in the anode flow path PAa based on whether this ratio is equal to or larger than a predetermined value. In the above embodiment, the hydrogen sensor 53 as a gas detection part is provided in the housing space SP0 inside the case, but the gas detection part may be provided in other locations, such as inside a motor case.

In the above embodiment, after stopping the operation of the fuel cell, the fuel gas and the oxidant gas are supplied to the anode flow path PAa and the cathode flow path PAc, respectively, to detect a gas leakage, but either the fuel gas or the oxidant gas may be supplied to the anode flow path PAa and the cathode flow path PAc, respectively, to detect the gas leakage. For example, a connection flow path connecting the flow path 210a for supplying the fuel gas and the flow path 220a for supplying the oxidant gas in FIG. 1 may be provided, and an on-off valve may be provided in the connection flow path, and during a gas leakage detection after stopping the operation of the fuel cell, the on-off valve may be opened to supply either the fuel gas or the oxidant gas to the anode flow path PAa and the cathode flow path PAc, respectively, and maintain the gas pressure in each the flow paths PAa and PAc at a predetermined value Pa to establish a flow-path blocking state.

In the above embodiment, an example of applying the fuel cell system 200 to a vehicle is described, but a fuel cell system of the present invention can also be applied to various industrial machines in addition to a moving body other than a vehicle such as an aircraft or a boat, a robot, and the like.

The above embodiment can be combined as desired with one or more of the above modifications. The modifications can also be combined with one another.

According to the present invention, it is possible to accurately detect fuel gas leakage.

Above, while the present invention has been described with reference to the preferred embodiments thereof, it will be understood, by those skilled in the art, that various changes and modifications may be made thereto without departing from the scope of the appended claims.

What is claimed is:

1. A fuel cell system comprising:
a fuel cell stack including a cell stacked body configured by stacking a plurality of power generation cells in a predetermined direction, an anode flow path in which a fuel gas flows and a cathode flow path in which an oxidant gas flows being provided inside the cell stacked body;
a fuel gas supply-discharge part configured to supply the fuel gas into the anode flow path and discharge the fuel gas from the anode flow path;
an oxidant gas supply-discharge part configured to supply the oxidant gas to the cathode flow path and discharge the oxidant gas from the cathode flow path;
a pressure detection part configured to detect a pressure in the anode flow path and a pressure in the cathode flow path; and
an electronic control unit including a microprocessor and a memory connected to the microprocessor, wherein
the microprocessor is configured to perform
detecting a leakage of the fuel gas from the anode flow path, based on the pressure in the anode flow path and the pressure in the cathode flow path detected by the pressure detection part, and
the detecting including controlling the fuel gas supply-discharge part and the oxidant gas supply-discharge part so as to be in a flow-path blocking state in which the anode flow path is blocked from the fuel gas supply-discharge part and the cathode flow path is blocked from the oxidant gas supply-discharge part with that the pressure in the anode flow path and the pressure in the cathode flow path maintained at a predetermined value after an operation of a fuel cell is stopped, and further detecting the leakage of the fuel gas based on a change amount or a change rate of the pressure in the anode flow path from the flow-path blocking state and a change amount or a change rate of the pressure in the cathode flow path from the flow-path blocking state.

2. The fuel cell system according to claim 1, wherein
the microprocessor is configured to perform
the detecting including determining whether the fuel gas leaks, based on the change amount or the change rate of the pressure in the anode flow path from the flow-path blocking state relative to the change amount or the change rate of the pressure in the cathode flow path from the flow-path blocking state.

3. The fuel cell system according to claim 1, wherein
the predetermined value is a first predetermined value smaller than a second predetermined value, and
the microprocessor is configured to perform
the detecting including determining whether the pressure in the anode flow path and the pressure in the cathode flow path after a lapse of a predetermined time from the flow-path blocking state are smaller than or equal to the second predetermined value, and determining that the fuel gas leaks when it is determined that the pressure in the anode flow path is smaller than or equal to the second predetermined value and the pressure in the cathode flow path is larger than the second predetermined value.

4. The fuel cell system according to claim 2, further comprising
a cooling medium supply-discharge part configured to supply a cooling medium into a cooling medium flow path adjacent to the anode flow path through a partition wall and discharge the cooling medium from the cooling medium flow path, wherein
the microprocessor is configured to perform
the detecting including determining that the fuel gas leaks from the anode flow path to an outside of the cell stacked body or from the anode flow path to the cooling medium flow path when a degree of decrease in the pressure in the anode flow path over time from the flow-path blocking state is larger than a degree of decrease in the pressure in the cathode flow path over time from the flow-path blocking state.

5. The fuel cell system according to claim 4, further comprising
a gas detection part configured to detect the fuel gas outside the cell stacked body, wherein
the microprocessor is configured to perform
the detecting including determining that the fuel gas leaks from the anode flow path to the outside of the cell stacked body when the fuel gas is detected by the gas detection part, and determining that the fuel gas leaks from the anode flow path to the cooling medium flow path when the fuel gas is not detected by the gas detection part, in a state that the degree of decrease in the pressure in the anode flow path over time from the flow-path blocking state is larger than the degree of decrease in the pressure in the cathode flow path over time from the flow-path blocking state.

6. The fuel cell system according to claim 1, wherein
the microprocessor is configured to perform
the detecting including controlling the fuel gas supply-discharge part and the oxidant gas supply-discharge part so as to simultaneously increase the pressure in the anode flow path and the pressure in the cathode flow path to the predetermined value after the operation of the fuel cell is stopped.

7. The fuel cell system according to claim 1, wherein
each of the plurality of power generation cells includes a unitized electrode assembly and a pair of separators disposed on both sides in the predetermined direction of the unitized electrode assembly, the unitized electrode assembly including a membrane electrode assembly configured as a joint body of an electrolyte membrane and an electrode and a frame supporting the membrane electrode assembly,
a seal portion is provided on a contact surface where each of the pair of separators contacts the frame, and
the anode flow path is provided between one of the pair of separators and the unitized electrode assembly in a state sealed by the seal portion.

8. The fuel cell system according to claim 7, wherein
the each of the pair of separators is configured by a pair of plates joined to each other by welding, and
a cooling medium flow path in which a cooling medium flows is formed between the pair of plates.

9. A gas leakage detection method of a fuel cell, the fuel cell including a cell stacked body configured by stacking a plurality of power generation cells in a predetermined direction, an anode flow path in which a fuel gas flows and a cathode flow path in which an oxidant gas flows being provided inside the cell stacked body,
the gas leakage detection method comprising:
increasing a pressure in the anode flow path and a pressure in the cathode flow path to a predetermined value after an operation of the fuel cell is stopped;
blocking the anode flow path and the cathode flow path with the pressure in the anode flow path and the pressure in the cathode flow path maintained at the predetermined value and establishing a flow-path blocking state; and
detecting a leakage of the fuel gas based on a change amount or a change rate of the pressure in the anode flow path and a change amount or a change rate of the pressure in the cathode flow path from the flow-path blocking state.
